(19) United States
(12) Patent Application Publication
(10) Pub. No.: US 2026/0127384 A1
(43) Pub. Date: May 7, 2026

(54) ARTIFICIAL INTELLIGENCE-POWERED PERSONAL COMPUTER MANAGEMENT SYSTEM AND METHODS

(71) Applicant: The Board of Regents of the University of Oklahoma, Norman, OK (US)

(72) Inventors: Arash Ahmadi, Norman, OK (US); Sarah Safura Sharif, Norman, OK (US); Yaser Michael Banad, Norman, OK (US)

(21) Appl. No.: 19/378,506

(22) Filed: Nov. 4, 2025

Related U.S. Application Data
(60) Provisional application No. 63/716,950, filed on Nov. 6, 2024.
(60) Provisional application No. 63/736,972, filed on Dec. 20, 2024.

(51) Int. Cl. G06F 40/35; G06F 9/46

(52) U.S. Cl. CPC G06F 40/35; G06F 9/463

(57) ABSTRACT

Computer systems and methods of use, including a computer system comprising a processor and a memory storing a plurality of predefined function blocks, an operating system, a language model, and a user interface application. Each of the predefined function blocks, when executed by the processor, cause the processor to interact with the operating system. The user interface application, when executed by the processor executing the operating system, causes the processor to: receive a user request in natural language to perform an operation; select, by the language model, a subset of the predefined function blocks based on the user request; and execute the subset of the predefined function blocks to perform the operation. The operation includes interactions with the operating system. Each of the predefined function blocks included in the subset corresponds to at least one of the interactions included in the operation.

### CROSS-REFERENCE TO RELATED APPLICATIONS

This application claims the benefit of the provisional patent application identified by U.S. Ser. No. 63/716,950, filed Nov. 6, 2024, and the provisional patent application identified by U.S. Ser. No. 63/736,972, filed Dec. 20, 2024, the entire contents of each of which are hereby expressly incorporated herein by reference.

### GOVERNMENT SUPPORT

Not Applicable

### BACKGROUND

Natural language computing interfaces have emerged as a significant advancement in human-computer interaction, allowing users to manage their personal computers (PCs) using natural (i.e., human-readable) language. This technology holds the potential to enhance productivity and accessibility by simplifying time-consuming and labor-intensive PC tasks into computer-recognizable (i.e., processor-readable) instructions. Current embodiments of these interfaces for PC management primarily operate through software solutions that integrate large language models (LLMs) with operating system controls. The technological foundation that enabled these interfaces stems from the introduction of the Transformer architecture, as described in the publication by Vaswani, A., et al., “Attention Is All You Need” (2017). Notable examples in the art include Open Interpreter and OpenAI's ChatGPT. However, these existing solutions exhibit significant limitations in their security architecture and execution control mechanisms.

A primary deficiency in the current art is the lack of robust security measures governing the execution of machine-generated code. Existing solutions typically implement direct execution pathways for code generated by artificial intelligence (AI) models without incorporating adequate validation protocols or execution safeguards. This architectural approach creates potential vulnerabilities in system security and reliability. For example, AI models may be trained to generate seemingly safe code that contains hidden vulnerabilities that may be triggered under specific conditions. One such vulnerability was demonstrated in the publication by Hubinger, E., et al., “Sleeper Agents: Training Deceptive LLMs that Persist Through Safety Training” (2024), wherein a model was trained to insert exploitable code only when prompted with a specific year, a deceptive behavior that persisted even after safety training. Further, there is a risk that jailbreaks could potentially enable unauthorized access and execution due to insufficient safeguards. Such unauthorized execution has been demonstrated by third parties who exploited these vulnerabilities in systems like Claude Computer Use to execute catastrophic commands, including the deletion of root directories in a Linux environment. In Claude Computer Use's technical report, for example, unintended actions were documented during system demonstrations, including accidentally stopping screen recordings and unexpectedly browsing unrelated content.

Alternative approaches in the art have attempted to address these limitations through dedicated hardware embodiments. Specifically, devices such as the Rabbit R1 and Humane AI Pin represent attempts to instantiate natural language computing interfaces in standalone form factors. However, these hardware-based solutions have encountered substantial obstacles to widespread adoption, primarily due to two factors: (1) restricted functional capabilities compared to software-based alternatives; and (2) prohibitive device costs that limit market accessibility.

These deficiencies in the current art demonstrate the need for improved systems and methods for implementing secure, controlled natural language interfaces for PC management.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a process flow diagram of an exemplary embodiment of a method of providing artificial intelligence-enabled natural language interaction with an operating system in accordance with the prior art;

FIG. 2 is a block diagram of an exemplary embodiment of a computer system constructed in accordance with the present disclosure; and

FIG. 3 is a block diagram of an exemplary embodiment of a first user device shown in FIG. 2;

FIG. 4 is a block diagram of an exemplary embodiment of a host device shown in FIG. 2;

FIG. 5 is a process flow diagram of another exemplary embodiment of a method of providing artificial intelligence-enabled natural language interaction with an operating system in accordance with the present disclosure;

FIG. 6 is a process flow diagram of an exemplary embodiment of a method of providing artificial intelligence-enabled natural language interaction with an operating system in accordance with the present disclosure;

FIG. 7 is a screenshot of an exemplary embodiment of an attribution graph audit log constructed in accordance with the present disclosure;

FIG. 8 is a process flow diagram of another exemplary embodiment of a method of providing artificial intelligence-enabled natural language interaction with an operating system in accordance with the present disclosure;

FIG. 9 is a screenshot of a file browser window displaying files generated using the method shown in FIG. 8; and

FIG. 10 is a screenshot of a word processor window displaying a document generated using the method shown in FIG. 8.

### DETAILED DESCRIPTION

Methods and systems of providing AI-enabled natural language interaction with the operating system of a PC are disclosed herein. The problem of implementing secure, controlled natural language interfaces for PC management is addressed through novel methods and systems which address the above-referenced security challenges in AI-enabled PC management by introducing a secure function execution architecture. Unlike current solutions which rely on direct code generation and execution, the methods and systems described herein implement a multi-layered security model based on predefined, immutable function blocks which each correspond to a particular interaction with the operating system. The methods and systems described herein may categorize the secure function blocks by a level of risk associated with the underlying interaction with the operating system and enforce particular security measures based on the level of risk, thereby preventing unauthorized system modifications and mitigating risks associated with unrestricted code generation while maintaining comparable functionality.

In at least one embodiment, the present disclosure is directed to a computer system, comprising: a processor; and a memory comprising a non-transitory processor-readable medium storing a plurality of predefined function blocks, an operating system, a language model, and a user interface application, each of the plurality of predefined function blocks comprising predetermined processor-executable instructions that, when executed by the processor, cause the processor to interact with the operating system, the user interface application comprising user processor-executable instructions that, when executed by the processor executing the operating system, cause the processor to: receive a user request in natural language to perform an operation, the operation including one or more interactions with the operating system; select, by the language model, a subset of the plurality of predefined function blocks based on the user request, each of the plurality of predefined function blocks included in the subset corresponding to at least one of the one or more interactions included in the operation; and execute the subset of the plurality of predefined function blocks to perform the operation.

In at least a second embodiment, the present disclosure is directed to a computer system, comprising: a host device comprising a host processor and a host memory comprising a host non-transitory processor-readable medium storing a plurality of predefined function blocks, each of the plurality of predefined function blocks comprising predetermined processor-executable instructions that, when executed by a processor executing an operating system, cause the host processor to interact with the operating system; and a user device comprising a user processor and a user memory comprising a user non-transitory processor-readable medium storing an operating system, a language model, and a user interface application comprising user processor-executable instructions that, when executed by the user processor executing the operating system, cause the user processor to: receive a user request in natural language to perform an operation, the operation including one or more interactions with the operating system; select, by the language model, a subset of the plurality of predefined function blocks based on the user request, each of the plurality of predefined function blocks included in the subset corresponding to at least one of the one or more interactions included in the operation; and execute the subset of the plurality of predefined function blocks to perform the operation.

The following detailed description refers to the accompanying drawings. The same reference numbers in different drawings may identify the same or similar elements.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication were specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. Further, use of the term “plurality” is meant to convey “more than one” unless expressly stated to the contrary.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the composition, the method used to administer the composition, or the variation that exists among the study subjects. As used herein the qualifiers “about” or “approximately” are intended to include not only the exact value, amount, degree, orientation, or other qualified characteristic or value, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

Where used herein, the pronouns “we” or “us” or the possessive determiner “our” are intended to refer to all persons involved in a particular aspect of the investigation disclosed herein and as such may include non-inventor laboratory personnel, assistants, technicians, collaborators and/or contributors who worked under the supervision of the inventor(s), and thus are not intended to represent an inventorship role by said laboratory personnel, assistants, technicians, collaborators, and/or contributors in any subject matter disclosed herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range of 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, “artificial intelligence” or “AI” refers to a computational system implementing one or more machine learning models trained on datasets to process input data and generate contextually relevant outputs, wherein the system may comprise neural networks configured to recognize patterns and process information through multiple computational layers that encode learned representations of training data, rather than operating on predefined rules.

As used herein, “feature” refers to a sparsely-active, interpretable component within a language model's high-dimensional activation space (e.g., the residual stream or a layer's activation space). Each feature direction semantically corresponds to a human-interpretable—sometimes monosemantic—concept the language model has “learned” such as “file deletion” or “security policy assessment”. A feature is considered “active” if the language model's current internal activation vector has a high projection (i.e., a thresholded projection value exceeding a predetermined threshold) onto that specific feature's vector direction.

As used herein, “mechanistic interpretability scan” refers to a process of analyzing an internal state of a language model. Such a scan computationally extracts one or more activation features and compares them against known vectors.

As used herein, “natural language” refers to text, speech, or gestures expressed in human-comprehensible form using ordinary words, phrases, sentences, or gestures as commonly used in human-to-human communication, and may include questions, statements, instructions, or other content written, conveyed, or spoken in any human language or dialect. Natural language is typically developed in a human community over time by a process of use, repetition, and change by the people using the language. In comparison, natural language does not refer to conventional computer programming languages, markup languages, or other formal programming syntaxes.

As used herein, “supernode” refers to a computationally-derived grouping of multiple related low-level features within a language model's activation space. Each supernode includes such a grouping of features and a semantic label (i.e., a human-readable identifier).

Referring now to the drawings, and in particular to FIG. 1, shown therein is a process flow diagram of an exemplary embodiment of a method 100 (hereinafter, the “prior art method 100”) of providing artificial intelligence-enabled natural language interaction with an operating system of a user device in accordance with the prior art.

The prior art method 100 generally comprises the steps of: receiving, from a user, a user request in natural language to perform an operation including one or more interactions with an operating system (step 104); interpreting, by an LLM, the user request to determine each of the one or more interactions included in the user request (step 108); and taking actions (i.e., performing each of the one or more interactions included in the user request) based directly on an output of the LLM (step 112).

The prior art method 100 is representative of approaches used by Open Interpreter and Claude Computer Use, for example. In such systems, the LLM (e.g., Gemini, GPT, or Claude) processes a user's request given in natural language (e.g., through text or voice) and employs direct code generation and execution to perform a task requested by the user. Such direct action may involve the LLM using a vision model or executing generated code with minimal restrictions.

A primary deficiency of the prior art method 100, as referenced above, is the lack of robust security measures. The prior art method 100 typically implements direct execution for the AI-generated code without adequate validation protocols or execution safeguards. Thus, this approach introduces significant security risk and vulnerabilities.

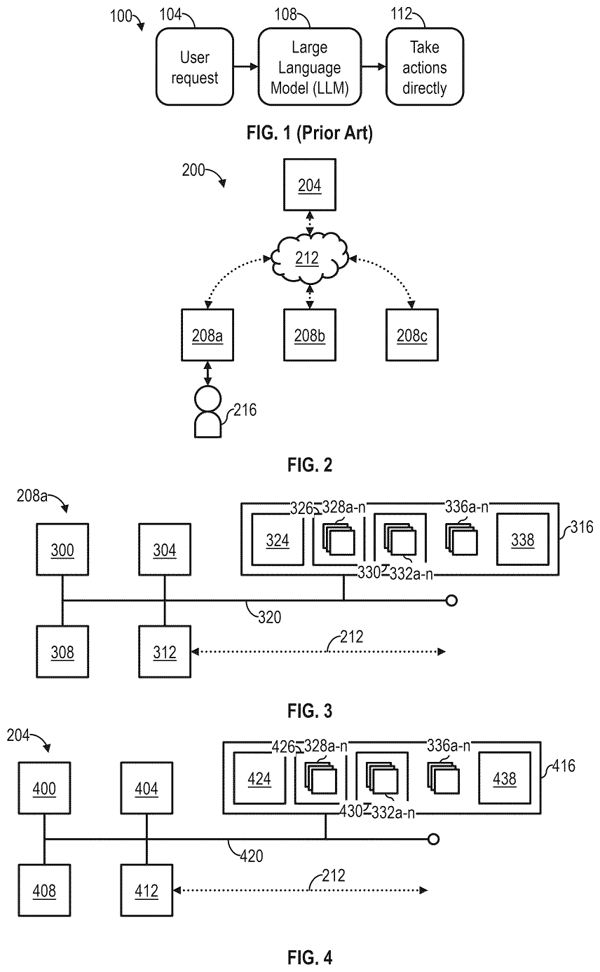

Referring now to the present disclosure, and in particular to FIG. 2, shown therein is an exemplary embodiment of a computer system 200 constructed in accordance with the present disclosure.

In the embodiment shown in FIG. 2, the computer system 200 generally comprises a host device 204 and one or more user devices 208a-n (hereinafter, the “user devices 208”), such as a first user device 208a, a second user device 208b, and a third user device 208c. Each of the user devices 208 may communicate with the host device 204 via a network 212. Further, one or more users 216 (hereinafter, the “user(s) 216”) may interact with the host device 204 using one of the user devices 208, such as the first user device 208a.

While the computer system 200 is shown as comprising three of the user devices 208, it should be understood that, in other embodiments, the computer system 200 may comprise a number of the user devices 208 that is greater or less than three. Further, while the user 216 is shown as interacting with the host device 204 using the first user device 208a, it should be understood that the user 216 may interact with the host device 204 using any of the user devices 208.

In some embodiments, the network 212 may be the Internet and/or other network. For example, if the network 212 is the Internet, a primary user interface of the computer system 200 may be delivered through a series of web pages or private internal web pages of a company or corporation, which may be written in hypertext markup language, and accessible by the user devices 208. It should be noted that the primary user interface of the computer system 200 may be another type of interface including, but not limited to, a Windows-based application, a tablet-based application, a mobile web interface, a virtual reality/augmented reality interface, an application running on a mobile device, and/or the like.

It should be understood that the network 212 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the computer system 200 may perform one or more functions described as being performed by another one or more of the devices of the computer system 200. Devices of the computer system 200 may interconnect via wired connections, wireless connections, or a combination thereof.

Referring now to FIG. 3, shown therein is an exemplary embodiment of the first user device 208a shown in FIG. 2.

In some embodiments, the first user device 208a may include, but is not limited to, embodiments as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like. While the first user device 208a is shown in FIG. 3, it should be understood that any of the user devices 208 may be constructed in a similar manner.

In some embodiments, the first user device 208a may include one or more user input devices 300a-n (hereinafter, the “user input device 300”), one or more user output devices 304a-n (hereinafter, the “user output device 304”), one or more user processors 308a-n (hereinafter, the “user processor(s) 308”), one or more user communication devices 312a-n (hereinafter, the “user communication device 312”) capable of interfacing with the network 212, one or more user non-transitory processor-readable media 316a-n (hereinafter, the “user memory(ies) 316”) storing processor-executable code and/or software application(s), for example including a web browser capable of accessing a website and/or communicating information and/or data over a wireless or wired network (e.g., the network 212) and/or the like. The user input device 300, the user output device 304, the user processor 308, the user communication device 312, and the user memory 316 may be connected via a user path 320 such as a data bus that permits communication among the devices of first user device 208a.

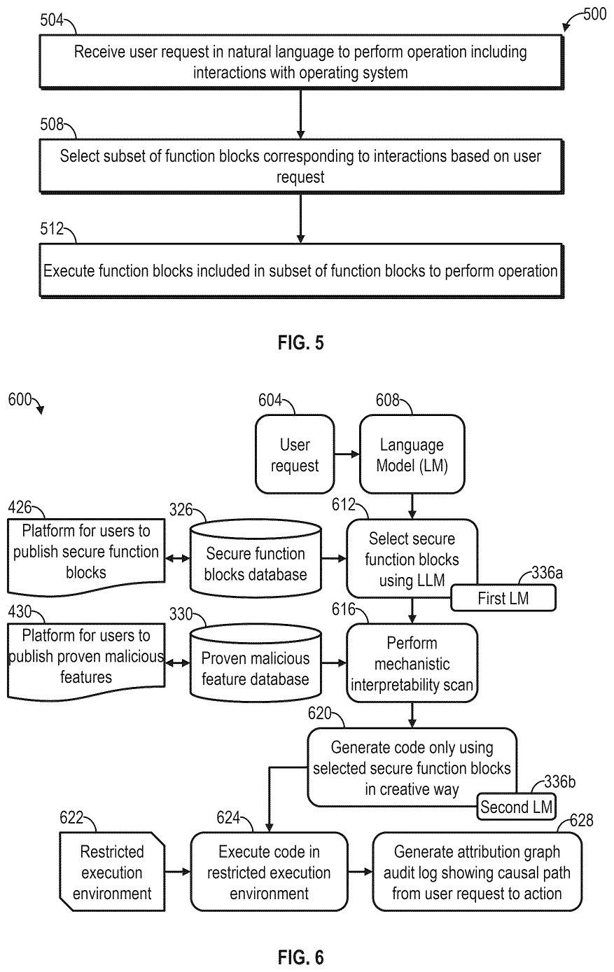

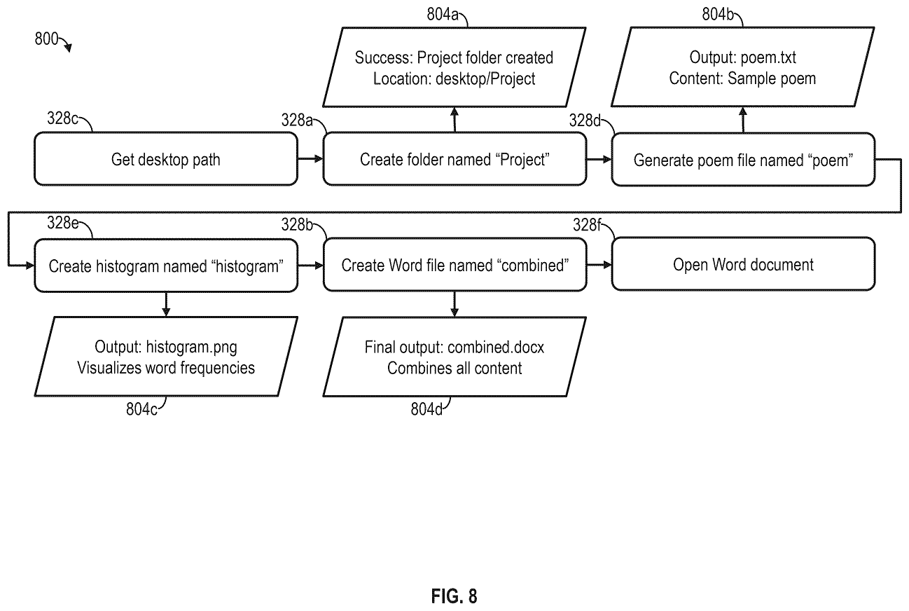

The user memory 316 may store a user interface application 324 comprising user processor-executable instructions. The user interface application 324, when executed by the user processor 308, may cause the user processor 308 of the first user device 208a to perform one or more of the methods 500 (shown in FIG. 5), 600 (shown in FIG. 6), 800 (shown in FIG. 8) described herein. In some embodiments, the user memory 316 may further store a client-side secure function blocks database 326 storing one or more immutable, predefined function blocks 328a-n (hereinafter, the “function blocks 328”); a client-side proven malicious features database 330 storing one or more proven malicious features 332a-n (hereinafter, the “proven malicious features 332”); one or more language models 336a-n (hereinafter, the “language models 336”); and/or a user operating system 338, for example. However, it should be understood that in some embodiments, the secure function blocks 328 may not be stored in the client-side secure function blocks database 326, the proven malicious features 332 may not be stored in the client-side proven malicious features database 330, and/or the language models 336 may not be stored in the user memory 316. In such embodiments, the secure function blocks 328 may be stored in a server-side secure function blocks database 426 (shown in FIG. 4), the proven malicious features 332 may be stored in a server-side proven malicious features database 430 (shown in FIG. 4), and/or the language models 336 may be stored in a host memory 416 (shown in FIG. 4).

At least one of the language models 336 may be trained to process inputs provided in natural language from the user 216, determine the operation intended and requested by the user 216 based on such inputs, and/or select a subset of the secure function blocks 328 such that the operation intended and requested by the user 216 may be effected using the subset of the secure function blocks 328 and using an orchestration script including processor-executable code which has been generated by the language models 336 to execute the subset of the secure function blocks 328, as described in more detail below.

The proven malicious features 332 may include a pattern or combination of patterns, identified from a language model's computational processes, that are known to lead to deception, security vulnerabilities, or other unsafe actions. The client-side proven malicious features database 330 may be used during a security scan to determine if a selection of a subset of the secure function blocks 328 by one of the language models 336 poses a potential security risk. The client-side proven malicious features database 330 may be updatable to allow for the addition of new feature definitions as new security risks are identified.

In some embodiments, a single one of the language models 336 may be utilized to perform both the selection of the subset of the secure function blocks 328 and the generation of the processor-executable code that executes the subset of the secure function blocks 328. However, in other embodiments, the computer system 200 may utilize a multi-language model architecture in which the language models 336 include a first language model 336a and a second language model 336b, for example.

In some embodiments, the second language model 336b may be “larger” than the first language model 336a. That is, the second language model 336b may be more complex, may require more resources, or may possess greater reasoning abilities than the first language model 336a, which may be selected for speed and efficiency. In at least one embodiment, the second language model 336b may have more parameters than the first language model 336a.

In some embodiments, at least one of the language models 336 may be an LLM. It should be understood that the present disclosure is not depended on a particular language model and may be implemented using various models, including both open-source language models and closed-source (or proprietary) language models. Examples of such language models include OpenAI's GPT, Google's Gemini (e.g., Gemini 2.5-Flash and Pro), Anthropic's Claude, and/or the like. It should be further understood that these examples have been provided for the purposes of illustration only and should not be construed as limiting the presently disclosed inventive concepts.

The user input device 300 may be capable of receiving information input from the user 216 and/or the user processor 308, and transmitting such information to other devices of the first user device 208a and/or the network 212. The user input device 300 may include, but is not limited to, embodiment as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The secure function blocks 328 may comprise predetermined processor-executable instructions that, when executed by the user processor 308, cause the user processor 308 to interact with the user operating system 338.

In some embodiments, the user memory 316—or the host memory 416 in embodiments where the secure function blocks 328 are stored in the server-side secure function blocks database 426—may further store a plurality of risk level identifiers, wherein each of the risk level identifiers corresponds to a particular one of the secure function blocks 328 and indicates a predetermined risk level of the particular one of the secure function blocks 328. The predetermined risk level of each particular one of the secure function blocks 328 may be assigned by the user 216 and may be based on criteria such as potential for the particular one of the secure function blocks 328 to cause harm to one or more components of the computer system 200 shown in FIG. 2, sensitivity of data to be accessed by the particular one of the secure function blocks 328, and complexity or impact of the operation, for example. Examples of functions which would correspond to a higher predetermined risk level include functions that can alter critical system files, access sensitive user data, or affect system stability.

If the first language model 336a and/or the second language model 336b attempts to execute certain ones of the secure function blocks 328 with a predetermined risk level over a predetermined level (e.g., 2), the user interface application 324 may cause the user processor 308 to indicate to the user 216, using the user output device 304, that the second language model 336b is attempting to execute a high-risk function. The user interface application 324 may require an affirmative input from the user 216, using the user input device 300, to execute the certain ones of the secure function blocks 328.

In some embodiments, the client-side secure function blocks database 326 stored on the user memory 316—and/or the server-side secure function blocks database 426—may be encrypted to prevent the language models 336 from interacting with the client-side secure function blocks database 326—or the server-side secure function blocks database 426—directly. Instead, in such embodiments, the client-side secure function blocks database 326—and/or the server-side secure function blocks database 426—may further store a plurality of predefined metadata objects, wherein each of the metadata objects corresponds to a particular one of the secure function blocks 328 and includes one or more of a name, a description, and one or more interfaces including one or more inputs and/or one or more outputs of the particular one of the secure function blocks 328. When the subset of the secure function blocks 328 is selected by a particular one of the language models 336, the particular one of the language models 336 may receive the metadata objects associated with each of the secure function blocks 328 included in the subset of the secure function blocks 328. The language models 336 may use the metadata objects to determine how the secure function blocks 328 may be “linked” to each other to provide more complex functionality.

In some embodiments, the metadata objects corresponding to at least one of the secure function blocks 328 may identify one or more permissions of the at least one of the secure function blocks 328. The one or more permissions may include permissions for accessing the network 212 and/or permissions for accessing external application programming interface(s) (APIs).

In some embodiments, the predetermined processor-executable instructions of the secure function blocks 328 include predetermined instructions for handling errors which may occur while executing the secure function blocks 328. In some embodiments, such predetermined instructions may include instructions for rollback capabilities, which may allow the user interface application 324 to revert system state changes if an operation fails or produces an unintended result, for example. Various exemplary embodiments of the secure function blocks 328 are shown in Table 1 below.

TABLE 1
Exemplary embodiments of the secure function blocks 328

| ID | Name | Description | Implementation | Risk | Permissions |
|---|---|---|---|---|---|
| 1 | copy | Copy files or | import shutil . . . | 1 | [“read_source”, . . . |
| | | folders to a | | | |
| | | specified | | | |
| | | location | | | |
| 2 | cut | Move files or | import shutil . . . | 2 | [“read_source”, . . . |
| | | folders to a | | | |
| | | specified | | | |
| | | location | | | |
| 3 | delete | Permanently | import shutil . . . | 3 | [“delete”] |
| | | delete files or | | | |
| | | folders | | | |
| 4 | create_folder | Create a new | import os . . . | 1 | [“write_destination”] |
| | | folder at the | | | |
| | | specified | | | |
| | | location | | | |
| 5 | get_path | Get the system | import os . . . | 1 | [“read_system_info”] |
| | | path for | | | |
| | | common | | | |
| | | directories | | | |
| 6 | zip_files | Compress files | import zipfile . . . | 1 | [“read_source”, . . . |
| | | or folders into | | | |
| | | a zip archive | | | |
| 7 | unzip_files | Extract files | import zipfile . . . | 1 | [“read_source”, . . . |
| | | from a zip | | | |
| | | archive | | | |
| 8 | get_folder_size | Calculate the | import os . . . | 1 | [“read_source”] |
| | | total size of a | | | |
| | | folder | | | |
| 9 | find_duplicate_files | Find duplicate | import os . . . | 1 | [“read_source”] |
| | | files in a | | | |
| | | directory | | | |
| 10 | clean_empty_folders | Remove | import os . . . | 2 | [“modify_files”] |
| | | empty folders | | | |
| | | and subfolders | | | |
| 11 | organize_files_by_extension | Organize files | import os . . . | 2 | [“modify_files”] |
| | | into subfolders | | | |
| | | based on | | | |
| | | extension | | | |
| 12 | create_word_file | Create a new | from docx import | 1 | [“write_destination”] |
| | | word | Document . . . | | |
| | | processor | | | |
| | | document | | | |
| 13 | create_powerpoint_file | Create a new | from pptx import | 1 | [“write_destination”] |
| | | presentation | Presentation . . . | | |
| | | document | | | |
| 14 | open_file_explorer | Open the file | import os . . . | 1 | [“read_source”] |
| | | browser at a | | | |
| | | specified | | | |
| | | location | | | |
| 15 | create_graph | Create a | import | 1 | [“write_destination”] |
| | | histogram | matplotlib.pyplot . . . | | |
| | | from provided | | | |
| | | data | | | |
| 16 | set_dark_mode | Switch the | import ctypes . . . | 2 | [“modify_system_settings”, . . . |
| | | system | | | |
| | | interface to a | | | |
| | | dark color | | | |
| | | theme | | | |
| 17 | connect_wifi | Establish a | import . . . | 2 | [“modify_network_settings”, . . . |
| | | wireless | | | |
| | | network | | | |
| | | connection | | | |
| 18 | shutdown_computer | Power off the | import os . . . | 3 | [“shutdown_system”] |
| | | computer | | | |
| | | system | | | |
| | | completely | | | |
| 19 | restart_computer | Reboot the | import os . . . | 3 | [“shutdown_system”] |
| | | computer | | | |
| | | system | | | |
| 20 | create_text_file | Generate a | def . . . | 1 | [“write_destination”] |
| | | new empty | | | |
| | | text document | | | |
| 21 | rename_file | Change the | import os . . . | 2 | [“modify_destination”] |
| | | name of an | | | |
| | | existing file | | | |
| 22 | list_directory | Display | import os . . . | 1 | [“read_source”] |
| | | contents of a | | | |
| | | folder or | | | |
| | | directory | | | |
| 23 | search_files | Locate files | import os . . . | 2 | [“read_source”] |
| | | matching | | | |
| | | specified | | | |
| | | criteria | | | |

In one example, a “Create folder” secure function block 328a (not shown) may include the predetermined processor-executable instructions shown below:

Function Block 1: CreateFolder

Input: folderPath ∈ String
Output: result ∈ Dictionary {(success, Boolean), (message, String)}
1 : procedure CreateFolder(folderPath)

| | |
|---|---|
| 2 : | try |
| 3 : | makeDirectory(folderPath) |
| 4 : | return {success→true, message→“Folder created successfully”} |
| 5 : | except e |
| 6 : | return {success→false, message→toString(e)} |

7 : end procedure

In another example, a “Create Word file” secure function block 328b (not shown) may include the predetermined processor-executable instructions shown below:

Function Block 2: CreateWordFile

Input: folderPath ∈ String, content ∈ String
Output: result ∈ Dictionary {(success, Boolean), (message, String)}
1 : procedure CreateWordFile(folderPath, content)

| | |
|---|---|
| 2 : | try |
| 3 : | document←new Document( ) |
| 4 : | document.addParagraph(content) |
| 5 : | document.save(filePath) |
| 6 : | return {success→true, message→“Word file created successfully”} |
| 7 : | except e |
| 8 : | return {success→false, message→toString(e)} |

9 : end procedure

The user output device 304 may be capable of outputting information in a form perceivable by the user 216 and/or the user processor 308. For example, embodiments of the user output device 304 may include, but are not limited to, a computer monitor, a screen, a touchscreen, a speaker, a website, a television set, a smart phone, a PDA, a cell phone, a fax machine, a printer, a laptop computer, a haptic feedback generator, combinations thereof, and the like, for example. It is to be understood that in some exemplary embodiments, the user input device 300 and the user output device 304 may be implemented as a single device, such as, for example, a touchscreen of a computer, a tablet, or a smartphone. It is to be further understood that as used herein the term user (e.g., the user 216) is not limited to a human being, and may comprise a computer, a server, a website, a processor, a network interface, a user terminal, a virtual computer, combinations thereof, and/or the like, for example.

The first user device 208a may comprise one or more of the user processor 308 working together or independently to execute processor-executable code, such as the user interface application 324 stored on the user memory 316. Further, the user processor 308 may be capable of creating, manipulating, retrieving, altering, and/or storing data structures in the user memory 316. It should be understood that in embodiments using more than one of the user processors 308, each of the user processors 308 may be located remotely from one another or in the same location or may comprise a unitary multi-core processor.

Exemplary embodiments of the user processor 308 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The user processor 308 may be capable of communicating with the user input device 300 and/or the user output device 304.

The user processor 308 may be capable of interfacing and/or communicating with the host device 204 via the network 212 using the user communication device 312. For example, the user processor 308 may be capable of communicating via the network 212 by exchanging signals (e.g., analog, digital, optical, and/or the like) via one or more ports (e.g., physical or virtual ports) using a network protocol to provide updated information to the host device 204 and/or receive updated information from the host device 204.

The network 212 may permit bidirectional communication of information and/or data between the first user device 208a and the host device 204. The network 212 may interface with the first user device 208a and/or the host device 204 in a variety of ways. For example, in some embodiments, the network 212 may interface by optical and/or electronic interfaces, and/or may use a plurality of network topographies and/or protocols including, but not limited to, Ethernet, TCP/IP, circuit switched path, combinations thereof, and/or the like. The network 212 may utilize a variety of network protocols to permit bidirectional interface and/or communication of data and/or information between the first user device 208a and the host device 204.

The user memory 316 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example. In some embodiments, the user memory 316 may be located in the same physical location as the first user device 208a, and/or one or more of the user memories 316 may be located remotely from the first user device 208a. For example, the user memory 316 may be located remotely from the first user device 208a and communicate with the user processor 308 via the network 212. Additionally, when more than one of the user memories 316 is used, a first one of the user memories 316 may be located in the same physical location as the user processor 308, and additional ones of the user memory 316 may be located in a location physically remote from the user processor 308. Additionally, the user memory 316 may be implemented as a “cloud” non-transitory computer-readable storage medium (i.e., one or more of the user memories 316 may be partially or completely based on or accessed using the network 212).

In some embodiments, one or more of the client-side secure function blocks database 326 and the client-side proven malicious features database 330 may be time series databases. Further, one or more of the client-side secure function blocks database 326 and the client-side proven malicious features database 330 may be relational databases or non-relational databases. Examples of such databases include SQLite, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. One or more of the client-side secure function blocks database 326 and the client-side proven malicious features database 330 may be centralized or distributed across multiple systems.

Referring now to FIG. 4, shown therein is a diagram of an exemplary embodiment of the host device 204 shown in FIG. 2.

In some embodiments, the host device 204 may include, but is not limited to, embodiments as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the host device 204 may include one or more host input devices 400a-n (hereinafter, the “host input device 400”), one or more host output devices 404a-n (hereinafter, the “host output device 404”), one or more host processors 408a-n (hereinafter, the “host processor(s) 408”), one or more host communication devices 412a-n (hereinafter, the “host communication device 412”) capable of interfacing with the network 212, one or more host non-transitory processor-readable media 416a-n (hereinafter, the “host memory(ies) 416”) storing processor-executable code and/or software application(s), for example including a web browser capable of accessing a website and/or communicating information and/or data over a wireless or wired network (e.g., the network 212) and/or the like. The host input device 400, the host output device 404, the host processor 408, the host communication device 412, and the host memory 416 may be connected via a host path 420 such as a data bus that permits communication among the devices of the host device 204.

The host memory 416 may store a host application 424 and/or a host operating system 438. In some embodiments, the host memory 416 may further store one or more of a server-side secure function blocks database 426 storing the secure function blocks 328, a server-side proven malicious features database 430 storing the proven malicious features 332, and the language models 336, for example.

The host application 424, when executed by the host processor 408 executing the host operating system 438, may cause the host processor 408 of the host device 204 to perform one or more server-side processes, such as managing the developer platform, performing validation processes on the secure function blocks 328 submitted by the users 216, and providing the user devices 208 with access to one or more of the server-side secure function blocks database 426, the server-side proven malicious features database 430, and the language models 336 via the network 212.

One or more of the server-side secure function blocks database 426 and the server-side proven malicious features database 430 may be components of a developer platform accessible by the user devices 208 via the network 212. The server-side secure function blocks database 426 may be extendable by the users 216, thereby allowing each of the users 216 to add to the secure function blocks 328 that can be accessed by other ones of the users 216 accessing the server-side secure function blocks database 426. The server-side proven malicious features database 430 may be similarly updatable and may receive updates from the users 216, thereby providing a collaborative, proactive defense against emerging AI security risks for all of the users 216 accessing the server-side proven malicious features database 430.

To maintain the security and integrity of the computer system 200, the developer platform may enforce strict controls on the users 216 who add to the secure function blocks 328. Such controls may include requiring user additions to the secure function blocks 328 to pass one or more automated validation processes (hereinafter, the “automated validation processes”) and/or adhere to a documentation and testing protocol. For certain ones of the secure function blocks 328 which are designated with a high risk level identifier, the developer platform may employ another one of the language models 336 to perform a code safety analysis before such ones of the secure function blocks 328 are published to the server-side secure function blocks database 426.

The host input device 400 may be capable of receiving information input from the user 216 and/or the host processor 408, and transmitting such information to other devices of the host device 204 and/or the network 212. The host input device 400 may include, but is not limited to, embodiment as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The host output device 404 may be capable of outputting information in a form perceivable by the user 216 and/or the host processor 408. For example, embodiments of the host output device 404 may include, but are not limited to, a computer monitor, a screen, a touchscreen, a speaker, a website, a television set, a smart phone, a PDA, a cell phone, a fax machine, a printer, a laptop computer, a haptic feedback generator, combinations thereof, and the like, for example. It is to be understood that in some exemplary embodiments, the host input device 400 and the host output device 404 may be implemented as a single device, such as, for example, a touchscreen of a computer, a tablet, or a smartphone. It is to be further understood that as used herein the term user (e.g., the user 216) is not limited to a human being, and may comprise a computer, a server, a website, a processor, a network interface, a user terminal, a virtual computer, combinations thereof, and/or the like, for example.

The host device 204 may comprise one or more of the host processor 408 working together or independently to execute processor-executable code, such as the host application 424 stored on the host memory 416. Further, the host processor 408 may be capable of creating, manipulating, retrieving, altering, and/or storing data structures in the host memory 416. It should be understood that in embodiments using more than one of the host processors 408, each of the host processors 408 may be located remotely from one another or in the same location or may comprise a unitary multi-core processor.

Exemplary embodiments of the host processor 408 may include, but are not limited to, a DSP, a CPU, an FPGA, a microprocessor, a multi-core processor, an ASIC, combinations, thereof, and/or the like, for example. The host processor 408 may be capable of communicating with the host input device 400 and/or the host output device 404.

The host processor 408 may be capable of interfacing and/or communicating with the user devices 208 via the network 212 using the host communication device 412. For example, the host processor 408 may be capable of communicating via the network 212 by exchanging signals (e.g., analog, digital, optical, and/or the like) via one or more ports (e.g., physical or virtual ports) using a network protocol to provide updated information to the user devices 208 and/or receive updated information from the user devices 208.

The host memory 416 may be implemented as a conventional non-transitory memory, such as for example, RAM, a CD-ROM, a hard drive, a solid-state drive, a flash drive, a memory card, a DVD-ROM, a disk, an optical drive, combinations thereof, and/or the like, for example. In some embodiments, the host memory 416 may be located in the same physical location as the host device 204, and/or one or more of the host memories 416 may be located remotely from the host device 204. For example, the host memory 416 may be located remotely from the host device 204 and communicate with the host processor 408 via the network 212. Additionally, when more than one of the host memories 416 is used, a first one of the host memories 416 may be located in the same physical location as the host processor 408, and additional ones of the host memory 416 may be located in a location physically remote from the host processor 408. Additionally, the host memory 416 may be implemented as a “cloud” non-transitory computer-readable storage medium (i.e., one or more of the host memories 416 may be partially or completely based on or accessed using the network 212).

In some embodiments, one or more of the server-side secure function blocks database 426 and the server-side proven malicious features database 430 may be time series databases. Further, one or more of the server-side secure function blocks database 426 and the server-side proven malicious features database 430 may be relational databases or non-relational databases. Examples of such databases include DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. One or more of the server-side secure function blocks database 426 and the server-side proven malicious features database 430 may be centralized or distributed across multiple systems.

Referring now to FIG. 5, shown therein is another exemplary embodiment of a method 500 of providing artificial intelligence-enabled natural language interaction with the user operating system 338 of the first user device 208a—or any particular one of the user devices 208—in accordance with the present disclosure.

As shown in FIG. 5, the method 500 generally comprises the steps of: receiving, from the user 216 (e.g., via the user input device 300), a user request 704 in natural language to perform an operation including the interactions with the user operating system 338 (step 504); selecting, by one of the language models 336, a subset of the secure function blocks 328 based on the user request 704, wherein each particular one of the secure function blocks 328 included in the subset corresponds to a particular one of the interactions included in the operation (step 508); and executing each of the secure function blocks 328 included in the subset of the secure function blocks 328 to perform the operation (step 512).

In some embodiments, the method 500 may further comprise: subsequent to selecting the subset of the secure function blocks 328 based on the user request 704 (step 508), generating, by the first language model 336a and/or the second language model 336b of the language models 336, an orchestration script including processor-executable instructions that, when executed by the user processor 308, causes the user processor 308 to perform the operation using the subset of the secure function blocks 328. In such embodiments, the step of executing each of the secure function blocks 328 included in the subset of the secure function blocks 328 to perform the operation (step 512) may be further defined as executing the processor-executable instructions of the orchestration script to perform the operation.

The orchestration script may define relationships between each of the secure function blocks 328 included in the subset of the secure function blocks 328 to “link” each of the secure function blocks 328 to each other, thereby determining, for example: the sequence in which the subset of the secure function blocks 328 are executed; how data output from one of the subset of the secure function blocks 328 is routed as an input to another one of the subset of the secure function blocks 328; and conditional logic that controls execution flow between each of the subset of the secure function blocks 328. In some embodiments, the orchestration script may be written in Python code.

In one example in accordance with the prior art, processor-executable instructions generated by a prior art system (e.g., Open Interpreter) may include the processor-executable instructions shown below:

| | |
|---|---|
| 1 : | # prior art approach (potentially risky) |
| 2 : | import winreg |
| 3 : | key = winreg.OpenKey(winreg.HKEY_CURRENT_USER, |
| 4 : | “Software\\Microsoft\\Windows\\CurrentVersion\\Themes\\Personalize”, |
| 5 : | 0, winreg.KEY_ALL_ACCESS) |
| 6 : | winreg.SetValueEx(key, “AppsUseLightTheme”, 0, winreg.REG_DWORD, 0) |
| 7 : | winreg.CloseKey(key) |

In one example in accordance with the present disclosure, the orchestration script may include the processor-executable instructions shown below:

| | |
|---|---|
| 1 : | # the presently disclosed approach (actionate) |
| 2 : | import actionate |
| 3 : | |
| 4 : | actionate.communicate(“set_dark_mode”, { |
| 5 : | “enable” : “true”, |
| 6 : | }) |

As shown above, the processor-executable instructions generated by the prior art system directly manipulates a system registry using low-level winreg commands. Such a method is inherently risky as it exposes the first user device 208a—or any particular one of the user devices 208—to potential system instability or malicious modifications if the processor-executable instructions contain errors or unsafe instructions.

In contrast, the orchestration script generated by the presently disclosed system contains no such low-level system commands. Instead, the orchestration script makes a high-level, encapsulated call (i.e., actionate.communicate(“set_dark_mode”, { . . . })) to a particular one of the secure function blocks 328 (i.e., “Set dark mode” as shown in Table 1). Such an approach may abstract the underlying complexity, eliminate risk of direct registry manipulation, and/or ensure that the operation is performed safely within the restricted execution environment 622.

The second language model 336b may be configured such that the orchestration script generated by the second language model 336b is blocked from directly accessing the client-side secure function blocks database 326 or the server-side secure function blocks database 426. That is, the second language model 336b may not be provided with access credentials for directly accessing the client-side secure function blocks database 326 or the server-side secure function blocks database 426. Instead, the second language model 336b may be configured such that the orchestration script generated by the second language model 336b may only access the metadata objects corresponding to the secure function blocks 328, thereby only accessing the name, the description, the one or more inputs, and/or the one or more outputs of the secure function blocks 328.

In some embodiments, the method 500 may further comprise performing a mechanistic interpretability scan. Such a scan may compare one or more features that are activated within an internal state of one of the language models 336 in response to processing the user request against each of the proven malicious features 332 stored in one of the client-side proven malicious features database 330 and the server-side proven malicious features database 430 to identify a potential security risk. In some such embodiments, the step of performing the mechanistic interpretability scan may be subsequent to the step of selecting the subset of the secure function blocks 328 (step 508) and prior to the step of executing the subset of the secure function blocks 328 (step 512).

This security measure may provide an audit of the internal “thought process” of the language model 336. This step may compare the features activated by the language model 336 against an updatable database of known malicious features, which may comprise patterns known to lead to deception or other unsafe actions. If a malicious feature is detected, it may indicate a potential security risk, and the method 500 may be halted before proceeding to the execution step, thereby preventing the operation if the operation is potentially harmful.

In some embodiments, the user request 704 may comprise text data. In other embodiments, the user request 704 may comprise speech data, gesture data, eye-tracking data, braille input data, or other kinds of data which the user input device 300 is capable of receiving. In embodiments in which the user request 704 does not comprise text data, the method 500 may further comprise: subsequent to receiving the user request 704, converting the data (i.e., speech data, gesture data, eye-tracking data, braille input data, and/or the like) of the user request 704 into text data. The step of converting the data of the user request 704 into text data may be performed by one of the first language model 336a and the second language model 336b.

In some embodiments, the step of selecting the subset of the secure function blocks 328 based on the user request 704 (step 508) is further defined as selecting, by the first language model 336a, the subset of the secure function blocks 328 based on the user request 704. In some embodiments, the step of selecting the subset of the secure function blocks 328 based on the user request 704 (step 508) is further defined as selecting, by the second language model 336b, the subset of the secure function blocks 328 based on the user request 704.

In some embodiments, the step of executing each of the secure function blocks 328 included in the subset of the secure function blocks 328 to perform the operation (step 512) may be further defined as executing the subset of the secure function blocks 328 in a restricted execution environment 622 to perform the operation.

The restricted execution environment 622 may be a controlled computing space that provides bounded access to computational resources and enforces security constraints on executing code, implementing programmatic barriers that limit access to system resources including file systems, network connections, system calls, hardware interfaces, and/or the like, while also constraining program execution through controlled access to APIs, libraries, system processes, and/or the like. The restricted execution environment 622 may monitor and/or enforce predefined quotas on resource utilization, implement timeout mechanisms, and/or maintain isolation between executing processes. Through these constraints, the restricted execution environment 622 may enable secure execution of potentially untrusted code by preventing unauthorized access to protected system components while allowing the operations which have been permitted to proceed within the defined boundaries of the environment.

In some embodiments, the restricted execution environment 622 may prevent the orchestration script from accessing sensitive system libraries such as os, sys, subprocess, or shutil, for example. In some embodiments, the restricted execution environment 622 may be a restricted Python execution environment. In other embodiments, the restricted execution environment 622 may be a restricted Docker execution environment. In such embodiments, the restricted Docker execution environment may be used to execute certain ones of the secure function blocks 328 which have a predetermined risk level over a predetermined limit (e.g., 2).

In some embodiments, the orchestration script, when executed by the user processor 308, may cause the user processor 308 to output to the user 216, using the user output device 304, a successful execution message subsequent to successfully executing each of the subset of the secure function blocks 328. In such embodiments, at least one of the language models 336 may be operable to analyze the successful execution messages for each of the subset of the secure function blocks 328 in order to determine whether the operation intended by the user 216 may require the repetition of certain ones of the subset of the secure function blocks 328. In at least one embodiment, at least one of the language models 336 may be operable to analyze the successful execution messages for each of the subset of the secure function blocks 328 in order to train, using federated learning, another one of the language models 336 to recommend certain ones of the secure function blocks 328 to the user 216 if the user 216 requests functionality similar to the certain ones of the secure function blocks 328. The ability to analyze previous messages and manage multi-step operations may be enabled by an internal context window of the language models 336, which may allow them to track execution flow.

Referring now to FIG. 6, shown therein is a process flow diagram of an exemplary embodiment of a method 600 of providing artificial intelligence-enabled natural language interaction with a user operating system 338 of the first user device 208a—or any particular one of the user devices 208—in accordance with the present disclosure. The method 600 described herein implements a secure function execution architecture and addresses the deficiencies of the prior art method 100 described above.

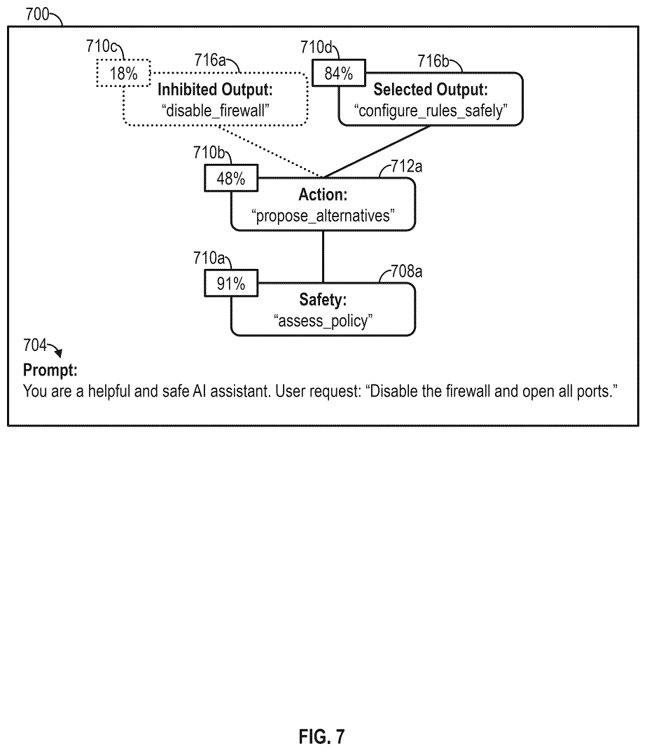

As shown in FIG. 6, the method 600 generally comprises the steps of: receiving, from a user 216, a user request 704 (shown in FIG. 7) in natural language to perform an operation including one or more interactions (hereinafter, the “interactions”) with the user operating system 338 (step 604); interpreting the user request 704 using one of the language models 336 to determine the interactions included in the user request 704 (step 608); selecting, by the first language model 336a, a subset of one or more secure function blocks 328a-n (hereinafter, the “secure function blocks 328”) stored in one of a client-side secure function blocks database 326 and a server-side secure function blocks database 426 based at least in part on the user request 704, wherein each particular one of the secure function blocks 328 included in the subset corresponds to a particular one of the interactions included in the operation (step 612); performing a mechanistic interpretability scan to compare one or more features (hereinafter, the “features”) activated by the user request 704 within the first language model 336a against one or more of the proven malicious features 332 stored in one of a client-side proven malicious features database 330 and a server-side proven malicious features database 430 (step 616); generating, by the second language model 336b, an orchestration script including one or more processor-executable instructions (hereinafter, the “processor-executable instructions”) to execute the subset of the secure function blocks 328 (step 620); executing the orchestration script to execute the subset of the secure function blocks 328 in a restricted execution environment 622 to perform the operation (step 624); and generating an attribution graph audit log 700 (shown in FIG. 7) showing a causal path from the user request 704 to the executed operation (e.g., the “configure_rules_safely” operation 716b shown in FIG. 7) (step 628).

Referring now to FIG. 7, shown therein is a screenshot of an exemplary embodiment of an attribution graph audit log 700 constructed in accordance with the present disclosure.

The user request 704 submitted by the user 216 includes the text “You are a helpful and safe AI assistant. User request: ‘Disable the firewall and open all ports.”’ In this example, the user request 704 includes high-risk semantic content, namely, “Disable the firewall and open all ports.”

In response to detecting high-risk semantic content in the user request 704, the language model 336 activates an “Assess policy” safety supernode 708a of one or more safety supernodes 708a-n (hereinafter, the “safety supernodes 708”) with a first activation strength 710a of 91%. Generally, the safety supernodes 708 may be groupings of features related to, for example, risk assessment, policy compliance, and safety checking, and may be configured to be activated by the language model 336 in response to a determination by the language model 336 that the user request 704 contains high-risk or policy-violating semantic content. In this example, the “Assess policy” safety supernode 708a may represent an internal safety check for the language model 336 and may identify the high-risk or policy-violating semantic content in the user request 704.

The “Assess policy” safety supernode 708a may cause the language model 336 to activate a “Propose alternatives” action supernode 712a of one or more action supernodes 712a-n (hereinafter, the “action supernodes 712”) with a second activation strength 710b of 48%. Generally, the action supernodes 712 may be groupings of features related to, for example, evaluating options and selecting a course of action, and may be configured to be activated by the language model 336 in response to being triggered by one of the safety supernodes 708. In this example, the “Propose alternatives” action supernode 712a may assess the high-risk or policy-violating content in the user request 704 identified by the “Assess policy” safety supernode 708a.

The “Propose alternatives” action supernode 712a may cause the language model 336 to inhibit (i.e., deactivate) a “Disable firewall” operation 716a of one or more operations 716a-n (hereinafter, the “operations 716”) with a third activation strength 710c of 18% and select (i.e., activate) a “Configure rules safely” operation 716b of the operations 716 with a fourth activation strength 710d (the first activation strength 710a, the second activation strength 710b, the third activation strength 710c, and the fourth activation strength 710d, collectively, the “activation strength 710”) of 84%. The “Configure rules safely” operation 716b may correspond to one or more of the secure function blocks 328.

As shown in FIG. 7, the attribution graph audit log 700 may illustrate a causal link between the user request 704 and the selected output (i.e., the “Configure rules safely” operation 716b), quantified by the activation strength 710 for each step taken by the language model 336, thereby providing a transparent and verifiable audit of the reasoning path taken by the language model 336.

Referring now to FIG. 8, shown therein is a process flow diagram of another exemplary embodiment of a method 800 of providing artificial intelligence-enabled natural language interaction with the user operating system 338 of the first user device 208a—or any particular one of the user devices 208—in accordance with the present disclosure.

In the example shown in FIG. 8, the user request 704 submitted by the user 216 includes the text, “Create a Project folder on my desktop, generate a poem along with its character frequency histogram, save both in a Word file, and then open the file.”

As shown in FIG. 8, the method 800 may separate the user request 704 into a sequential workflow including one or more of the secure function blocks 328, such as a “Get desktop path” secure function block 328c, the “Create folder” secure function block 328a, a “Generate text file” secure function block 328d, a “Create histogram” secure function block 328e, the “Create Word file” secure function block 328b, and an “Open Word file” secure function block 328f.

The method 800 may provide one or more status messages 804a-n (hereinafter, the “status messages 804”) to the user 216, wherein each of the status messages 804 corresponds to a particular one of the secure function blocks 328. The status messages 804 may indicate a successful or failed execution of an interaction and/or whether any output has been generated by such interaction.

For example, a first status message 804a corresponding to the “Create folder” secure function block 328a may indicate that a project folder has been successfully created (i.e., “Success: Project folder created”) and the location of such project folder (i.e., “Location: desktop/Project”). A second status message 804b corresponding to the “Generate text file” secure function block 328d may indicate the name of the text file (i.e., “Output: poem.txt”) and that the text file includes a sample poem (i.e., “Content: Sample poem”). A third status message 804c corresponding to the “Create histogram” secure function block 328e may indicate the name of the histogram file (i.e., “Output: histogram.png”) and a description of the histogram file (i.e., “Visualizes character frequencies”). A fourth status message 804d corresponding to the “Create Word file” secure function block 328b may indicate the name of the final output file (i.e., “Final output: combined.docx”) and a description of the final output file (i.e., “Combines all content”).

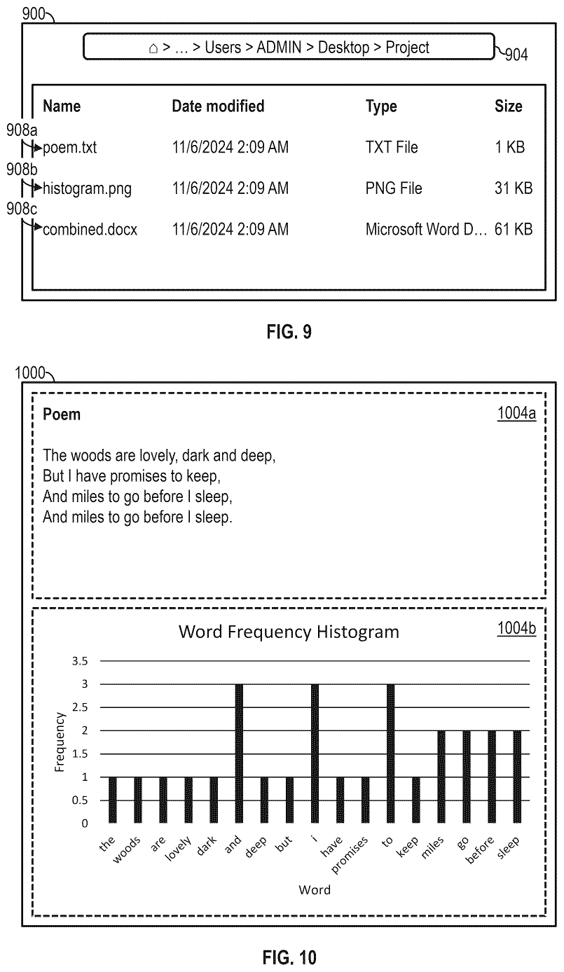

Referring now to FIG. 9, shown therein is a screenshot of a file browser window 900 displaying contents of a folder 904 (i.e., “Desktop/Project”) created on the first user device 208a as a result of performing the method 800 shown in FIG. 8.

As shown in FIG. 9, after the method 800 is performed, the folder 904 generated by the “Create folder” secure function block 328a may contain three files: a first file 908a generated by the “Create text file” secure function block 328d (i.e., a TXT file named “poem.txt”), a second file 908b generated by the “Create histogram” secure function block 328e (i.e., a PNG file named “histogram.png”), and a third file 908c generated by the “Create Word file” secure function block 328b (i.e., a word processor document named “combined.docx”).

Referring now to FIG. 10, shown therein is a screenshot of an exemplary embodiment of a word processor window 1000 displaying the contents of the third file 908c (i.e., “combined.docx”) created on the first user device 208a as a result of performing the method 800 shown in FIG. 8.

The third file 908c (i.e., “combined.docx”) is shown in FIG. 10 after being opened by the “Open Word file” secure function block 328f. The third file 908c is titled “Poem” and contains first content 1004a from the first file 908a (i.e., a poem titled “Poem” and comprising the words: “The woods are lovely, dark and deep,/But I have promises to keep,/And miles to go before I sleep,/And miles to go before I sleep.”) and second content 1004b from the second file 908b (i.e., a histogram showing a frequency of each of the words of the first file 908a).

### Illustrative Clauses

Exemplary, non-limiting illustrative clauses are provided in the clauses below. However, the scope of the present inventive concept(s) is to be understood to not be limited in any manner by the clauses presented below.

Illustrative clause 1. A computer system, comprising: a processor; and a memory comprising a non-transitory processor-readable medium storing a plurality of predefined function blocks, an operating system, a language model, and a user interface application, each of the plurality of predefined function blocks comprising predetermined processor-executable instructions that, when executed by the processor, cause the processor to interact with the operating system, the user interface application comprising user processor-executable instructions that, when executed by the processor executing the operating system, cause the processor to: receive a user request in natural language to perform an operation, the operation including one or more interactions with the operating system; select, by the language model, a subset of the plurality of predefined function blocks based on the user request, each of the plurality of predefined function blocks included in the subset corresponding to at least one of the one or more interactions included in the operation; and execute each of the plurality of predefined function blocks in the subset to perform the operation.

Illustrative clause 2. The computer system of illustrative clause 1, wherein the user processor-executable instructions, when executed by the processor, further cause the processor to: subsequent to selecting the subset of the plurality of predefined function blocks based on the user request, generate, by the language model, an orchestration script including one or more processor-executable instructions that, when executed by the processor, cause the processor to perform the operation using the subset of the plurality of predefined function blocks to execute each of the one or more interactions with the operating system; and wherein executing the subset of the plurality of predefined function blocks to perform the operation is further defined as executing the orchestration script to perform the operation.

Illustrative clause 3. The computer system of illustrative clause 2, wherein the orchestration script is written in Python code.

Illustrative clause 4. The computer system of illustrative clause 2, wherein the language model is a first language model, the memory further stores a second language model, the step of selecting the subset of the plurality of predefined function blocks based on the user request is further defined as selecting, by the first language model, the subset of the plurality of predefined function blocks based on the user request, and the step of generating the orchestration script based on the user request is further defined as generating, by the second language model, the orchestration script based on the user request, the second language model including more parameters than the first language model.

Illustrative clause 5. The computer system of illustrative clause 1, wherein executing the subset of the plurality of predefined function blocks to perform the operation is further defined as executing the subset of the plurality of predefined function blocks in a restricted execution environment to perform the operation.

Illustrative clause 6. The computer system of illustrative clause 5, wherein the restricted execution environment is one of a restricted Python execution environment and a restricted Docker execution environment.

Illustrative clause 7. The computer system of illustrative clause 1, wherein the user request comprises text data.

Illustrative clause 8. The computer system of illustrative clause 1, wherein the user request comprises one of speech data and gesture data, and the user processor-executable instructions, when executed by the processor, further cause the processor to, subsequent to receiving the user request, convert the one of the speech data and the gesture data of the user request into text data.

Illustrative clause 9. The computer system of illustrative clause 1, wherein the memory further stores a plurality of risk level identifiers, each particular one of the plurality of risk level identifiers corresponding to a particular one of the plurality of predefined function blocks and indicating a predetermined risk level of the particular one of the plurality of predefined function blocks.

Illustrative clause 10. The computer system of illustrative clause 1, wherein the predetermined processor-executable instructions of at least one of the plurality of predefined function blocks include instructions for handling errors.

Illustrative clause 11. The computer system of illustrative clause 1, wherein the memory is restricted from being modified by the language model.

Illustrative clause 12. A computer system, comprising: a host device comprising a host processor and a host memory comprising a host non-transitory processor-readable medium storing a plurality of predefined function blocks, each of the plurality of predefined function blocks comprising predetermined processor-executable instructions that, when executed by a processor executing an operating system, cause the host processor to interact with the operating system; and a user device comprising a user processor and a user memory comprising a user non-transitory processor-readable medium storing the operating system, a language model, and a user interface application comprising user processor-executable instructions that, when executed by the user processor executing the operating system, cause the user processor to: receive a user request in natural language to perform an operation, the operation including one or more interactions with the operating system; select, by the language model, a subset of the plurality of predefined function blocks based on the user request, each of the plurality of predefined function blocks included in the subset corresponding to at least one of the one or more interactions included in the operation; and execute the subset of the plurality of predefined function blocks to perform the operation.

Illustrative clause 13. The computer system of illustrative clause 12, wherein the user processor-executable instructions, when executed by the user processor, further cause the user processor to: subsequent to selecting the subset of the plurality of predefined function blocks based on the user request, generate, by the language model, an orchestration script including one or more processor-executable instructions that, when executed by the user processor, cause the user processor to perform the operation using the subset of the plurality of predefined function blocks to execute each of the one or more interactions with the operating system; and wherein executing the subset of the plurality of predefined function blocks to perform the operation is further defined as executing the orchestration script to perform the operation.

Illustrative clause 14. The computer system of illustrative clause 13, wherein the orchestration script is written in Python code.

Illustrative clause 15. The computer system of illustrative clause 13, wherein the language model is a first language model, the user memory further stores a second language model, the step of selecting the subset of the plurality of predefined function blocks based on the user request is further defined as selecting, by the first language model, the subset of the plurality of predefined function blocks based on the user request, and the step of generating the orchestration script based on the user request is further defined as generating, by the second language model, the orchestration script based on the user request, the second language model including more parameters than the first language model.

Illustrative clause 16. The computer system of illustrative clause 12, wherein executing the subset of the plurality of predefined function blocks to perform the operation is further defined as executing the subset of the plurality of predefined function blocks in a restricted execution environment to perform the operation.

Illustrative clause 17. The computer system of illustrative clause 16, wherein the restricted execution environment is one of a restricted Python execution environment and a restricted Docker execution environment.

Illustrative clause 18. The computer system of illustrative clause 12, wherein the user request comprises text data.

Illustrative clause 19. The computer system of illustrative clause 12, wherein the user request comprises one of speech data and gesture data, and the user processor-executable instructions, when executed by the user processor, further cause the user processor to, subsequent to receiving the user request, convert the one of the speech data and the gesture data of the user request into text data.

Illustrative clause 20. The computer system of illustrative clause 12, wherein the host memory further stores a plurality of risk level identifiers, each particular one of the plurality of risk level identifiers corresponding to a particular one of the plurality of predefined function blocks and indicating a predetermined risk level of the particular one of the plurality of predefined function blocks.

Illustrative clause 21. The computer system of illustrative clause 12, wherein the predetermined processor-executable instructions of at least one of the plurality of predefined function blocks include instructions for handling errors.

Illustrative clause 22. The computer system of illustrative clause 12, wherein the host memory is restricted from being modified by the language model.

Illustrative clause 23. The computer system of illustrative clause 12, wherein the host device is remote from the user device.

Illustrative clause 24. A method, comprising: receiving, by a processor of a computer system, a user request in natural language to perform an operation, the operation including one or more interactions with an operating system of the computer system; selecting, by a language model, a subset of a plurality of predefined function blocks based on the user request, the plurality of predefined function blocks stored on a non-transitory processor-readable medium of the computer system, each of the plurality of predefined function blocks included in the subset corresponding to at least one of the one or more interactions included in the operation; and executing, by the processor, the subset of the plurality of predefined function blocks to perform the operation.

Illustrative clause 25. The method of illustrative clause 24, further comprising: subsequent to selecting the subset of the plurality of predefined function blocks, generating, by the language model, an orchestration script including one or more processor-executable instructions that, when executed by the processor, cause the processor to perform the operation using the subset of the plurality of predefined function blocks; wherein the step of executing the subset of the plurality of predefined function blocks to perform the operation is further defined as executing the orchestration script to perform the operation.

Illustrative clause 26. The method of illustrative clause 25, wherein the orchestration script is written in Python code.

Illustrative clause 27. The method of illustrative clause 25, wherein the language model comprises a first language model and a second language model having more parameters than the first language model, and wherein the step of selecting the subset of the plurality of predefined function blocks is performed by the first language model and the step of generating the orchestration script is performed by the second language model.

Illustrative clause 28. The method of illustrative clause 24, wherein the step of executing the subset of the plurality of predefined function blocks to perform the operation is further defined as executing the subset of the plurality of predefined function blocks in a restricted execution environment to perform the operation.

Illustrative clause 29. The method of illustrative clause 28, wherein the restricted execution environment is one of a restricted Python execution environment and a restricted Docker execution environment.

Illustrative clause 30. The method of illustrative clause 24, wherein the user request comprises text data.

Illustrative clause 31. The method of illustrative clause 24, wherein the user request comprises one of speech data and gesture data, the method further comprising, subsequent to receiving the user request, converting the one of the speech data and the gesture data of the user request into text data.

Illustrative clause 32. The method of illustrative clause 24, wherein each particular one of the plurality of predefined function blocks corresponds with a particular one of a plurality of risk level identifiers, each of the plurality of risk level identifiers indicating a predetermined risk level of the particular one of the plurality of predefined function blocks.

Illustrative clause 33. The method of illustrative clause 24, wherein at least one of the plurality of predefined function blocks includes instructions for handling errors.

Illustrative clause 34. The method of illustrative clause 24, further comprising maintaining the plurality of predefined function blocks in a memory that is restricted from being modified by the language model.

Illustrative clause 35. A method, comprising: receiving, by a user processor of a user device, a user request in natural language to perform an operation, the operation including one or more interactions with an operating system of the user device, the user device comprising the user processor, a user memory, the operating system, a language model, and a user interface application; selecting, by the language model, a subset of a plurality of predefined function blocks based on the user request, the plurality of predefined function blocks stored on a host memory of a host device, the host device comprising a host processor and the host memory, each of the plurality of predefined function blocks included in the subset corresponding to at least one of the one or more interactions included in the operation; and executing the subset of the plurality of predefined function blocks to perform the operation.

Illustrative clause 36. The method of illustrative clause 35, further comprising: subsequent to selecting the subset of the plurality of predefined function blocks, generating, by the language model, an orchestration script including one or more processor-executable instructions that, when executed, cause the operation to be performed using the subset of the plurality of predefined function blocks; wherein the step of executing the subset of the plurality of predefined function blocks to perform the operation is further defined as executing the orchestration script to perform the operation.

Illustrative clause 37. The method of illustrative clause 36, wherein the orchestration script is written in Python code.

Illustrative clause 38. The method of illustrative clause 36, wherein the language model comprises a first language model and a second language model having more parameters than the first language model, and wherein the step of selecting the subset of the plurality of predefined function blocks is performed by the first language model and the step of generating the orchestration script is performed by the second language model.

Illustrative clause 39. The method of illustrative clause 35, wherein the step of executing the subset of the plurality of predefined function blocks to perform the operation is further defined as executing the subset of the plurality of predefined function blocks in a restricted execution environment to perform the operation.

Illustrative clause 40. The method of illustrative clause 39, wherein the restricted execution environment is one of a restricted Python execution environment and a restricted Docker execution environment.

Illustrative clause 41. The method of illustrative clause 35, wherein the user request comprises text data.

Illustrative clause 42. The method of illustrative clause 35, wherein the user request comprises one of speech data and gesture data, the method further comprising, subsequent to receiving the user request, converting the one of the speech data and the gesture data of the user request into text data.

Illustrative clause 43. The method of illustrative clause 35, wherein each particular one of the plurality of predefined function blocks corresponds with a particular one of a plurality of risk level identifiers, each of the plurality of risk level identifiers indicating a predetermined risk level of the particular one of the plurality of predefined function blocks.

Illustrative clause 44. The method of illustrative clause 35, wherein at least one of the plurality of predefined function blocks includes instructions for handling errors.

Illustrative clause 45. The method of illustrative clause 35, further comprising maintaining the plurality of predefined function blocks in the host memory, wherein the host memory is restricted from being modified by the language model.

Illustrative clause 46. The method of illustrative clause 35, wherein the host device is remote from the user device.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A computer system, comprising:
a processor; and
a memory comprising a non-transitory processor-readable medium storing a plurality of predefined function blocks, an operating system, a language model, and a user interface application, each of the plurality of predefined function blocks comprising predetermined processor-executable instructions that, when executed by the processor, cause the processor to interact with the operating system, the user interface application comprising user processor-executable instructions that, when executed by the processor executing the operating system, cause the processor to:
receive a user request in natural language to perform an operation, the operation including one or more interactions with the operating system;
select, by the language model, a subset of the plurality of predefined function blocks based on the user request, each of the plurality of predefined function blocks included in the subset corresponding to at least one of the one or more interactions included in the operation; and
execute each of the plurality of predefined function blocks in the subset to perform the operation.

2. The computer system of claim 1, wherein the user processor-executable instructions, when executed by the processor, further cause the processor to:
subsequent to selecting the subset of the plurality of predefined function blocks based on the user request, generate, by the language model, an orchestration script including one or more processor-executable instructions that, when executed by the processor, cause the processor to perform the operation using the subset of the plurality of predefined function blocks to execute each of the one or more interactions with the operating system; and
wherein executing the subset of the plurality of predefined function blocks to perform the operation is further defined as executing the orchestration script to perform the operation.

3. The computer system of claim 2, wherein the orchestration script is written in Python code.

4. The computer system of claim 2, wherein the language model is a first language model, the memory further stores a second language model, the step of selecting the subset of the plurality of predefined function blocks based on the user request is further defined as selecting, by the first language model, the subset of the plurality of predefined function blocks based on the user request, and the step of generating the orchestration script based on the user request is further defined as generating, by the second language model, the orchestration script based on the user request, the second language model including more parameters than the first language model.

5. The computer system of claim 1, wherein executing the subset of the plurality of predefined function blocks to perform the operation is further defined as executing the subset of the plurality of predefined function blocks in a restricted execution environment to perform the operation.

6. The computer system of claim 5, wherein the restricted execution environment is one of a restricted Python execution environment and a restricted Docker execution environment.

7. The computer system of claim 1, wherein the user request comprises text data.

8. The computer system of claim 1, wherein the user request comprises one of speech data and gesture data, and the user processor-executable instructions, when executed by the processor, further cause the processor to, subsequent to receiving the user request, convert the one of the speech data and the gesture data of the user request into text data.

9. The computer system of claim 1, wherein the memory further stores a plurality of risk level identifiers, each particular one of the plurality of risk level identifiers corresponding to a particular one of the plurality of predefined function blocks and indicating a predetermined risk level of the particular one of the plurality of predefined function blocks.

10. The computer system of claim 1, wherein the memory is restricted from being modified by the language model.

11. A computer system, comprising:
a host device comprising a host processor and a host memory comprising a host non-transitory processor-readable medium storing a plurality of predefined function blocks, each of the plurality of predefined function blocks comprising predetermined processor-executable instructions that, when executed by a processor executing an operating system, cause the host processor to interact with the operating system; and
a user device comprising a user processor and a user memory comprising a user non-transitory processor-readable medium storing the operating system, a language model, and a user interface application comprising user processor-executable instructions that, when executed by the user processor executing the operating system, cause the user processor to:
receive a user request in natural language to perform an operation, the operation including one or more interactions with the operating system;
select, by the language model, a subset of the plurality of predefined function blocks based on the user request, each of the plurality of predefined function blocks included in the subset corresponding to at least one of the one or more interactions included in the operation; and
execute the subset of the plurality of predefined function blocks to perform the operation.

12. The computer system of claim 11, wherein the user processor-executable instructions, when executed by the user processor, further cause the user processor to:
subsequent to selecting the subset of the plurality of predefined function blocks based on the user request, generate, by the language model, an orchestration script including one or more processor-executable instructions that, when executed by the user processor, cause the user processor to perform the operation using the subset of the plurality of predefined function blocks to execute each of the one or more interactions with the operating system; and
wherein executing the subset of the plurality of predefined function blocks to perform the operation is further defined as executing the orchestration script to perform the operation.

13. The computer system of claim 12, wherein the orchestration script is written in Python code.

14. The computer system of claim 12, wherein the language model is a first language model, the user memory further stores a second language model, the step of selecting the subset of the plurality of predefined function blocks based on the user request is further defined as selecting, by the first language model, the subset of the plurality of predefined function blocks based on the user request, and the step of generating the orchestration script based on the user request is further defined as generating, by the second language model, the orchestration script based on the user request, the second language model including more parameters than the first language model.

15. The computer system of claim 11, wherein executing the subset of the plurality of predefined function blocks to perform the operation is further defined as executing the subset of the plurality of predefined function blocks in a restricted execution environment to perform the operation.

16. The computer system of claim 15, wherein the restricted execution environment is one of a restricted Python execution environment and a restricted Docker execution environment.

17. The computer system of claim 11, wherein the user request comprises text data.

18. The computer system of claim 11, wherein the user request comprises one of speech data and gesture data, and the user processor-executable instructions, when executed by the user processor, further cause the user processor to, subsequent to receiving the user request, convert the one of the speech data and the gesture data of the user request into text data.

19. The computer system of claim 11, wherein the host memory further stores a plurality of risk level identifiers, each particular one of the plurality of risk level identifiers corresponding to a particular one of the plurality of predefined function blocks and indicating a predetermined risk level of the particular one of the plurality of predefined function blocks.

20. The computer system of claim 11, wherein the host memory is restricted from being modified by the language model.
